(19) United States
(12) Patent Application Publication
(10) Pub. No.: US 2010/0064066 A1
(43) Pub. Date: Mar. 11, 2010

(54) KVM switch system and interface adapter for detecting interface of computer

(75) Inventor: Chen-Wei Ho, Shijr City (TW)

Correspondence Address: Patterson & Sherldan - ATEN, 3040 Post Oak Boulevard, Suite 1500, Houston, TX, 77056, US

(73) Assignee: ATEN INTERNATIONAL CO., LTD., Taipei (TW)

(21) Appl. No.: 12/230,862

(22) Filed: Sep. 5, 2008

(51) Int. Cl. G06F 3/00

(52) U.S. Cl. 710/15

(57) ABSTRACT

A keyboard-video-mouse (KVM) switch system capable of detecting an interface of a computer and an interface adapter used therefor are provided. The KVM switch system includes a computer connector, a processor, and a detecting link. The computer connector is coupled to a computer. The processor is coupled to the computer connector with the detecting link connected therebetween. The processor outputs a first signal to the computer via the computer connector when the processor detects that the detecting link provides a first level and outputs a second signal when the interface adapter is connected between the computer connector and the computer, therefore, the processor detects that the detecting link and the computer provide a second level. The interface adapter has a PS/2 interface and a USB interface. A reserved pin of the PS/2 interface is connected to a power pin of the USB interface.

### FIELD OF THE INVENTION

The present invention generally relates to a keyboard-video-mouse (KVM) switch, and more particularly to a KVM switch system capable of detecting an interface of a computer coupled thereto and an interface adapter used therefor.

### BACKGROUND OF THE INVENTION

A KVM switch allows a user to use a keyboard, a monitor, and a mouse to control a plurality of computers as if the keyboard, the mouse and the monitor are directly connected to the computers. For computers, the most basic peripheral devices are a keyboard and a mouse. If a user wants to control computers equipped with a PS/2 keyboard and a PS/2 mouse, he has to use a cable with PS/2 interface to connect to the computers. But there are more and more computers equipped with universal serial bus (USB) interface instead of PS/2 interface. In this case, if a user wants to control computers equipped with USB interface, he has to use a cable with USB interface to connect to the computers. That is, for connecting to different computer interfaces, the user has to prepare different cables with different interfaces for connecting to computers; one is a PS/2 interface for connecting to computers equipped with PS/2 interface, and the other is a USB interface for connecting to computers equipped with USB interface. It seems to be inconvenient to change the cables corresponding to the different interfaces of the computers. In addition, maintaining two cables can be a burden if controlling a large number of computers becomes reality.

A Taiwan issued model innovation Patent No. M302727 discloses a cable used in a KVM switch. The cable comprises a first video signal port, a USB signal port, a PS/2 signal port, a main wire, and a second video signal port. The patent discloses the USB signal port could be cascaded with a PS/2 adapter for connecting to PS/2 interface of a computer. The USB signal port cascaded with the PS/2 port adapter just transforms a USB signal to a PS/2 signal. When the cable is connected to the KVM switch, the KVM switch does not detect an interface of a computer coupled thereto.

### SUMMARY OF THE INVENTION

An objective of the present invention is to provide a KVM switch system capable of detecting an interface of a computer coupled thereto and outputting a signal corresponding to the interface of the computer.

Another objective of the present invention is to provide an interface adapter used in a KVM switch system for connecting a computer having an interface different from the KVM switch system.

The KVM switch system of the present invention comprises a computer connector, a processor, and a detecting link. The computer connector is coupled to a computer and has at least one detecting pin. The processor is coupled to the computer connector. The detecting link is connected between the detecting pin and the processor. The processor outputs a first signal to the computer via the computer connector when the processor detects that the detecting link provides a first level. The processor outputs a second signal to the computer via the computer connector when the processor detects that the detecting link and the computer provide a second level. The processor detects that the detecting link is at the second level when an interface adapter is connected between the computer connector and the computer. That the detecting link is at the first level or the second level depends on a voltage level of the detecting pin.

The interface adapter of the present invention has a PS/2 interface and a USB interface. A reserved pin of the PS/2 interface is connected to a power pin of the USB interface for providing a voltage level to a detecting link of a KVM switch system through a detecting pin of a computer connector of the KVM switch system. The voltage level is generated by the detecting link and the computer. The power pin of the USB interface is a V_{bus} pin or a ground pin.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a block diagram of a KVM switch system according to the first embodiment of the present invention;

FIG. 2 shows a block diagram of a KVM switch system according to the second embodiment of the present invention;

FIG. 3A shows a diagram of pins-connection to the interface adapter in FIG. 2;

FIG. 3B shows another diagram of pins-connection to the interface adapter in FIG. 2;

FIG. 4A shows a detailed diagram of the computer connector, the processor, the detecting link, and the selector, based on the interface adapter in FIG. 3A;

FIG. 4B shows another detailed diagram of the computer connector, the processor, the detecting link, and another type of the selector, based on the interface adapter in FIG. 3A;

FIG. 4C shows a detailed diagram of the computer connector, the processor, the detecting link, and the selector, based on the interface adapter in FIG. 3B;

FIG. 4D shows another detailed diagram of the computer connector, the processor, the detecting link, and another type of the selector, based on the interface adapter in FIG. 3B;

FIG. 5 shows a diagram of a cable; and

FIG. 6 shows a diagram of another type of cable.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

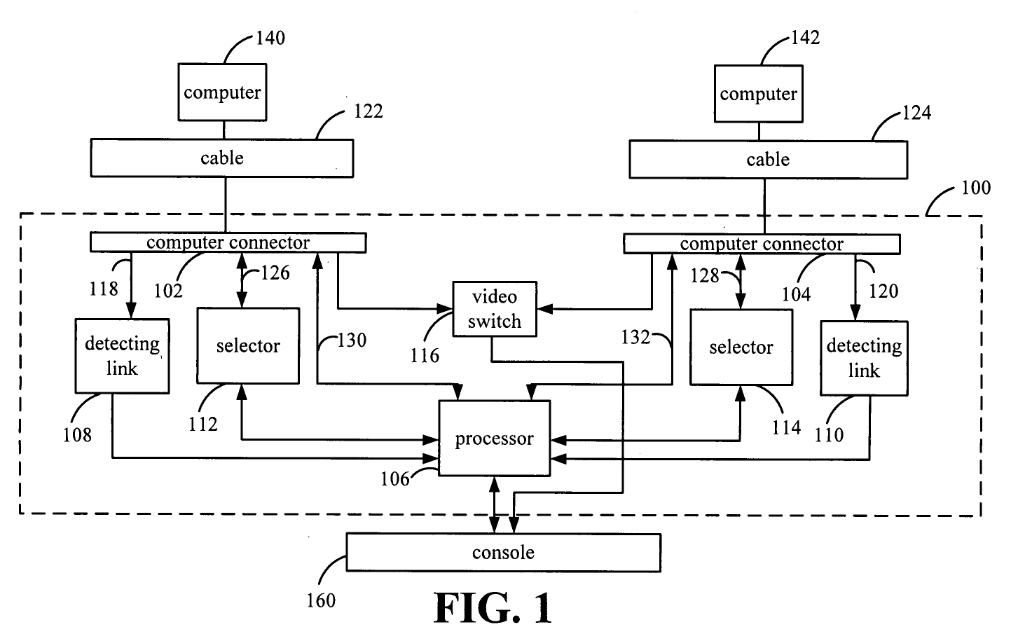

Please refer to FIG. 1, which shows a block diagram of a KVM switch system 100 according to the first embodiment of the present invention. In this embodiment, the KVM switch system 100 couples at least two computers 140, 142 to a console 160. The console 160 comprises at least a keyboard, a display, and a mouse for controlling the computer 140 and the computer 142. The keyboard and the mouse of console 160 could be a PS/2 interface or a USB interface. The KVM switch system 100 comprises computer connectors 102, 104, a processor 106, detecting links 108, 110, selectors 112, 114, and a video switch 116. The computer connector 102 is coupled to the computer 140 via a cable 122 and coupled to the video switch 116. The computer connector 104 is coupled to the computer 142 via a cable 124 and coupled to the video switch 116. The computer connector 102 has a detecting pin 118, and the computer connector 104 also has a detecting pin 120. The processor 106 is coupled to the computer connector 102 and the computer connector 104. The detecting link 108 is connected between the detecting pin 118 and the processor 106, and the detecting link 110 is connected between the detecting pin 120 and the processor 106. The selector 112 couples between the computer connector 102 and the processor 106. The selector 114 couples between the computer connector 104 and the processor 106. The processor 106 outputs a first signal to the computer 140 via the computer connector 102 when the processor 106 detects that the detecting link 108 provides a first level. The processor 106 outputs a second signal to the computer 140 via the computer connector 102 when the processor 106 detects that the detecting link 108 and the computer 140 provide a second level.

When the computer 140 has a PS/2 interface, e.g. a PS/2 keyboard or a PS/2 mouse interface, the detecting pin 118 is at a first level. The first level is a voltage level generated by the detecting link 108. The detecting pin 118 may be connected to a reserved pin of the PS/2 keyboard interface or a reserved pin of the PS/2 mouse interface of the computer connector 102. For example, the detecting pin 118 is connected to a reserved pin of the PS/2 keyboard interface herein. Then the detecting link 108 provides the first level to the processor 106. The processor 106 enables the selector 112 to output a PS/2 keyboard signal 126 to the computer connector 102, and it outputs a PS/2 mouse signal 130 to the computer connector 102 based on the first level received and detected. Finally, the PS/2 keyboard signal 126 and the PS/2 mouse signal 130 are transferred to the computer 140 via the cable 122.

In one embodiment, the detecting pin 118 is connected to a reserved pin of the PS/2 mouse interface herein. Then the detecting link 108 provides the first level to the processor 106. The processor 106 enables the selector 112 to output a PS/2 mouse signal 126 to the computer connector 102, and it outputs a PS/2 keyboard signal 130 to the computer connector 102 based on the first level received and detected. Finally, the PS/2 mouse signal 126 and the PS/2 keyboard signal 130 are transferred to the computer 140 via the cable 122.

Similarly, the computer 142 is functioning at the same manner as the computer 140. That is, when the computer 142 has a PS/2 interface, e.g. a PS/2 keyboard or a PS/2 mouse interface, the detecting pin 120 is at a first level. The first level is a voltage level generated by the detecting link 110. The detecting pin 120 may be connected to a reserved pin of the PS/2 keyboard interface or a reserved pin of the PS/2 mouse interface of the computer connector 104. For example, the detecting pin 120 is connected to a reserved pin of the PS/2 keyboard interface herein. Then the detecting link 110 provides the first level to the processor 106. The processor 106 enables the selector 114 to output a PS/2 keyboard signal 128 to the computer connector 104, and it outputs a PS/2 mouse signal 132 to the computer connector 104 based on the first level received and detected. Finally, the PS/2 keyboard signal 128 and the PS/2 mouse signal 132 are transferred to the computer 142 via the cable 124.

In one embodiment, the detecting pin 120 is connected to a reserved pin of the PS/2 mouse interface herein. Then the detecting link 110 provides the first level to the processor 106. The processor 106 enables the selector 114 to output a PS/2 mouse signal 128 to the computer connector 104, and it outputs a PS/2 keyboard signal 132 to the computer connector 104 based on the first level received and detected. Finally, the PS/2 mouse signal 128 and the PS/2 keyboard signal 132 are transferred to the computer 142 via the cable 124. A video signal is switched by the video switch 116 and transmitted from the computer 140 or the computer 142 to the console 160.

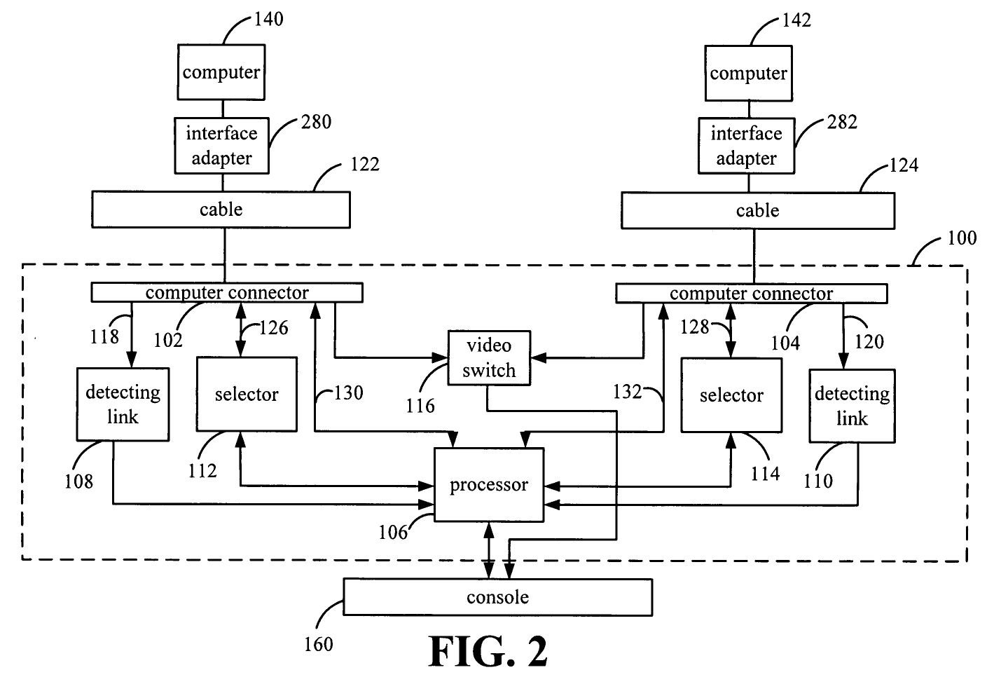

Please refer to FIG. 2, which shows a block diagram of a KVM switch system 100 according to the second embodiment of the present invention. In this embodiment, the KVM switch system 100 couples at least two computers 140, 142 to a console 160. The console 160 comprises at least a keyboard, a display, and a mouse for controlling the computer 140 and the computer 142. The KVM switch system 100 comprises computer connectors 102, 104, a processor 106, detecting links 108, 110, selectors 112, 114, and a video switch 116. The computer connector 102 is coupled to the computer 140 via a cable 122 and coupled to the video switch 116. The computer connector 104 is coupled to the computer 142 via a cable 124 and coupled to the video switch 116. The computer connector 102 has a detecting pin 118, and the computer connector 104 also has a detecting pin 120. The processor 106 is coupled to the computer connector 102 and the computer connector 104. The detecting link 108 is connected between the detecting pin 118 and the processor 106, and the detecting link 110 is connected between the detecting pin 120 and the processor 106. The selector 112 couples between the computer connector 102 and the processor 106. The selector 114 couples between the computer connector 104 and the processor 106.

When an interface adapter 280 is coupled between the cable 122 and the computer 140, the detecting pin 118 is at a second level, rather than the first level. The second level is a voltage level generated by the computer 140 and the detecting link 108. In one embodiment, the interface adapter 280 comprises a PS/2 interface having a reserved pin, and a USB interface having a power pin (V_{bus}) connected to the reserved pin of PS/2 interface. In another embodiment, the interface adapter 280 comprises a PS/2 interface having a reserved pin, and a USB interface having a ground pin (GND) connected to the reserved pin of PS/2 interface. Detailed descriptions of the interface adapter 280 will be described later and not be limited thereto abovementioned descriptions. The PS/2 interface of the interface adapter 280 is connected to the cable 122, and the USB interface of the interface adapter 280 is connected to the computer 140. The detecting link 108 and the computer 140 provide the second level detected from the detecting pin 118 to the processor 106. The processor 106 enables the selector 112 to output a USB keyboard signal 126 to the computer connector 102, and it outputs a USB mouse signal 130 to the computer connector 102 according to commands of processor 106 based on the first level received and detected. Finally, the USB keyboard signal 126 and the USB mouse signal 130 are transferred to the computer 140 via the cable 122 and the interface adapter 280.

In one embodiment, the processor 106 enables the selector 112 to output a USB mouse signal 126 to the computer connector 102, and it outputs a USB keyboard signal 130 to the computer connector 102 according to commands of processor 106 based on the first level received and detected. Finally, the USB mouse signal 126 and the USB keyboard signal 130 are transferred to the computer 140 via the cable 122 and the interface adapter 280.

In another embodiment, the processor 106 enables the selector 112 to output a USB mouse and keyboard signal 126 to the computer connector 102 according to commands of processor 106 based on the first level received and detected. Finally, the USB mouse and keyboard signal 126 is transferred to the computer 140 via the cable 122 and the interface adapter 280.

Similarly, the computer 142 is functioning at the same manner as the computer 140. When an interface adapter 282 is coupled between the cable 124 and the computer 142, the detecting pin 120 is at a second level, rather than the first level. The second level is a voltage level generated by the computer 142 and the detecting link 110. In one embodiment, the interface adapter 282 comprises a PS/2 interface having a reserved pin, and a USB interface having a power pin (V_{bus}) connected to the reserved pin of PS/2 interface. In another embodiment, the interface adapter 282 comprises a PS/2 interface having a reserved pin, and a USB interface having a ground pin (GND) connected to the reserved pin of PS/2 interface. Detailed descriptions of the interface adapter 282 will be described later and not be limited thereto abovementioned descriptions. The PS/2 interface of the interface adapter 282 is connected to the cable 124, and the USB interface of the interface adapter 282 is connected to the computer 142. The detecting link 110 and the computer 142 provide the second level detected from the detecting pin 120 to the processor 106. The processor 106 enables the selector 114 to output a USB keyboard signal 128 to the computer connector 104, and it outputs a USB mouse signal 132 to the computer connector 104 according to commands of processor 106 based on the first level received and detected. Finally, the USB keyboard signal 128 and the USB mouse signal 132 are transferred to the computer 142 via the cable 124 and the interface adapter 282.

In one embodiment, the processor 106 enables the selector 114 to output a USB mouse signal 128 to the computer connector 104, and it outputs a USB keyboard signal 132 to the computer connector 104 according to commands of processor 106 based on the first level received and detected. Finally, the USB mouse signal 128 and the USB keyboard signal 132 are transferred to the computer 142 via the cable 124 and the interface adapter 282.

In another embodiment, the processor 106 enables the selector 114 to output a USB mouse and keyboard signal 128 to the computer connector 104 according to commands of processor 106 based on the first level received and detected. Finally, the USB mouse and keyboard signal 128 is transferred to the computer 142 via the cable 124 and the interface adapter 282. A video signal is switched by the video switch 116 and transmitted from the computer 140 or the computer 142 to the console 160.

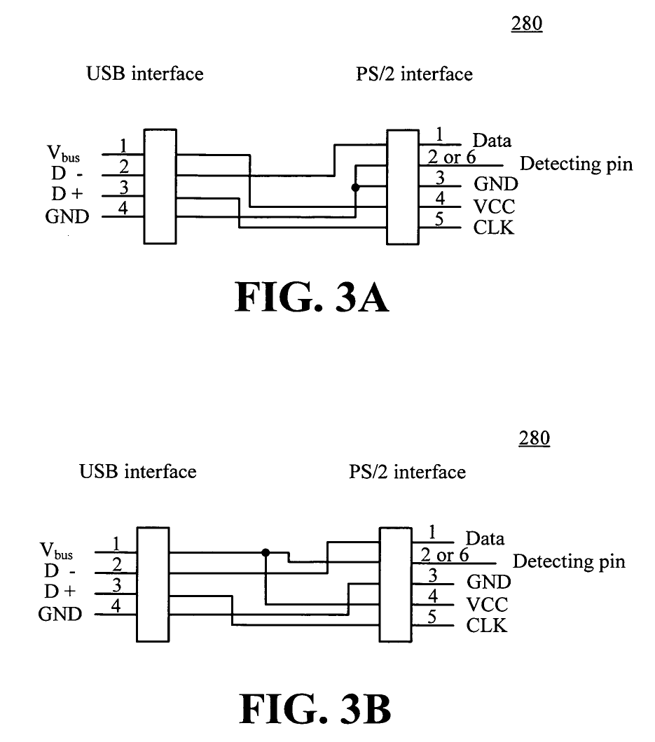

Please refer to FIG. 3A, which shows a diagram of pins-connection to the interface adapter 280 in FIG. 2. The USB interface of the interface adapter 280 includes four pins. Pin 1 of the USB interface is used for transferring a V_{bus} signal. Pin 2 of the USB interface is used for transferring a D− signal. Pin 3 of the USB interface is used for transferring a D+ signal. Pin 4 of the USB interface is a ground pin (GND). The PS/2 interface of the interface adapter 280 includes six pins such as Mini-Din 6. Pin 1 of the PS/2 interface is used for transferring a Data signal. Pin 3 of the PS/2 interface is a ground pin (GND). Pin 4 of the PS/2 interface is used for transferring a VCC signal. Pin 5 of the PS/2 interface is used for transferring a CLK signal. Pin 2 and Pin 6 of the PS/2 interface are reserved pins. Pin 1 of the USB interface is connected to Pin 4 of the PS/2 interface. Pin 2 of the USB interface is connected to Pin 1 of the PS/2 interface. Pin 3 of the USB interface is connected to Pin 5 of the PS/2 interface. Pin 4 of the USB interface is connected to Pin 3 of the PS/2 interface. Specifically, by using the reserved Pin 2 or Pin 6 connected to the GND pin of the USB interface, the USB level can be produced and transmitted to the detecting pin 118 or 120 in FIG. 2. The pin assignment of the interface adapter 282 is the same as that of the interface adapter 280.

Please refer to FIG. 3B, which shows another diagram of pins-connection to the interface adapter 280 in FIG. 2. The USB interface of the interface adapter 280 includes four pins. As described above, Pin 1 of the USB interface is used for transferring a V_{bus} signal, Pin 2 of the USB interface is used for transferring a D− signal, Pin 3 of the USB interface is used for transferring a D+ signal, and Pin 4 of the USB interface is a ground pin (GND). The PS/2 interface of the interface adapter 280 includes six pins such as Mini-Din 6. Pin 1 of the PS/2 interface is used for transferring a Data signal. Pin 3 of the PS/2 interface is a ground pin (GND). Pin 4 of the PS/2 interface is used for transferring a VCC signal. Pin 5 of the PS/2 interface is used for transferring a CLK signal. Pin 2 and Pin 6 of the PS/2 interface are reserved pins. Pin 1 of the USB interface is connected to Pin 4 of the PS/2 interface. Pin 2 of the USB interface is connected to Pin 1 of the PS/2 interface. Pin 3 of the USB interface is connected to Pin 5 of the PS/2 interface. Pin 4 of the USB interface is connected to Pin 3 of the PS/2 interface. A major difference between in FIG. 3A and in FIG. 3B is that the reserved Pin 2 or Pin 6 of the PS/2 interface in FIG. 3B is connected to the V_{bus} pin of the USB interface. Thus, the USB level can be produced and transmitted to the detecting pin 118 or 120 in FIG. 2. The pin assignment of the interface adapter 282 is the same as that of the interface adapter 280.

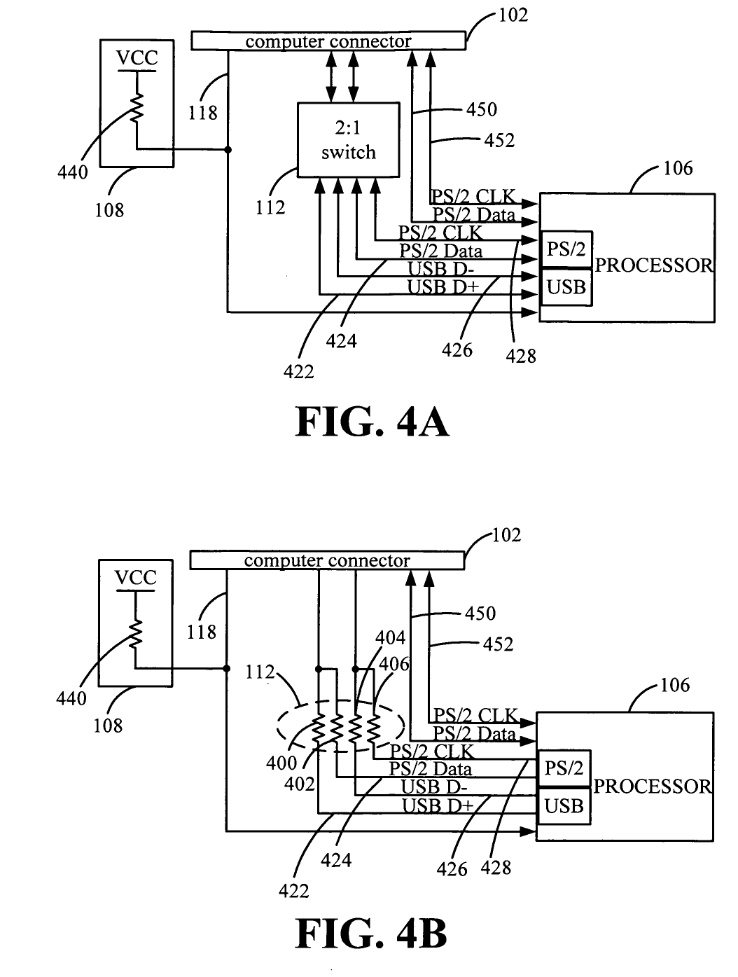

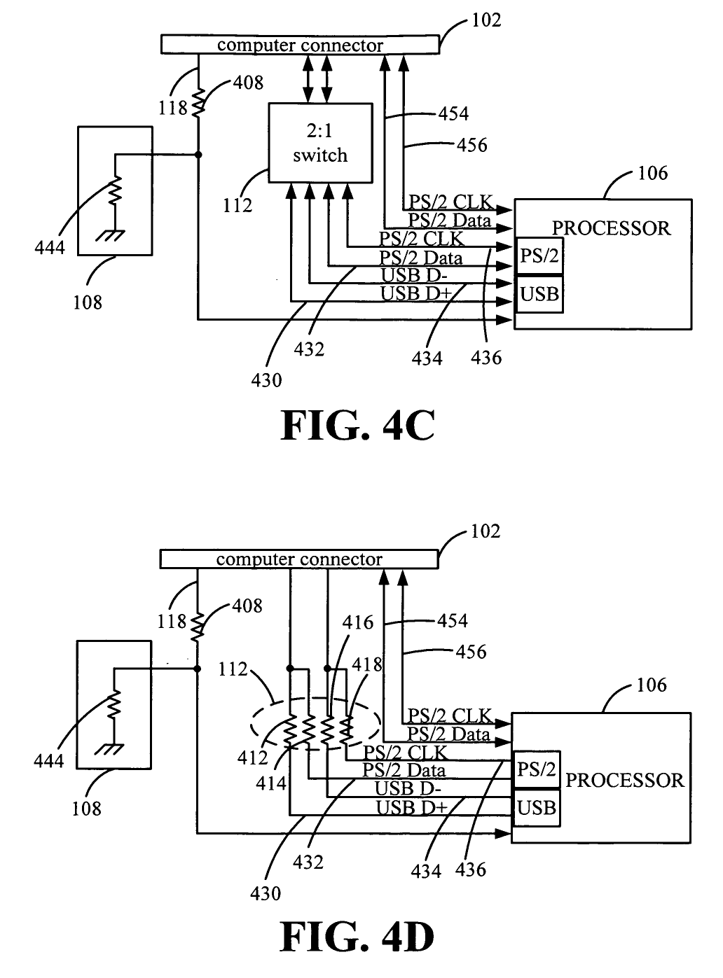

Please refer to FIG. 4A. FIG. 4A shows a detailed diagram of the computer connector 102, the processor 106, the detecting link 108, and the selector 112, based on the interface adapter 280 in FIG. 3A. In FIG. 3A, the reserved Pin 2 or reserved Pin 6 of the PS/2 interface is connected to the GND pin of the USB interface. The detecting link 108 comprises a resistor 440, a first end of the resistor 440 is connected to a power supply terminal VCC, and a second end of the resistor 440 is connected to the detecting pin 118. In one embodiment, the selector 112 is a 2:1 switch. The processor 106 controls the 2:1 switch to route PS/2 signals when the processor 106 detects that the detecting link 108 provides a first level. The processor 106 controls the 2:1 switch to route USB signals when the processor 106 detects that the detecting link 108 and the computer 140 provide a second level. In another embodiment, the 2:1 switch may be connected to the detecting link 108 and is not controlled by the processor 106. The 2:1 switch is switched to route PS/2 signals when the detecting link 108 provides a first level. The 2:1 switch is switched to route USB signals when the detecting link 108 and the computer 140 provide a second level. The processor 106 outputs one of the PS/2 signals and the USB signals and enables the selector 112 to output the PS/2 signals or the USB signals to the computer connector 102 depending on the voltage level of the detecting pin 118, i.e. according to the interface of the computer 140.

In one embodiment, the processor 106 outputs PS/2 mouse signals to the selector 112 via a PS/2 CLK signal line 428 and a PS/2 Data signal line 424 when the processor 106 outputs PS/2 keyboard signals to the computer connector 102 via a PS/2 CLK signal line 452 and a PS/2 Data signal line 450.

In another embodiment, the processor 106 outputs PS/2 keyboard signals to the selector 112 via the PS/2 CLK signal line 428 and the PS/2 Data signal line 424 when the processor outputs the PS/2 mouse signals to the computer connector 102 via the PS/2 CLK signal line 452 and the PS/2 Data signal line 450.

When the 2:1 switch routes USB signals between the computer connector 102 and the processor 106, the 2:1 switch may route USB keyboard and mouse signals via a USB D+ signal line 422 and a USB D− signal line 426. In one embodiment, the 2:1 switch may route USB keyboard signals via the USB D+ signal line 422 and the USB D− signal line 426, and PS/2 mouse signals may be transmitted via the PS/2 Data signal line 450 and the PS/2 CLK signal line 452 between the computer connector 102 and the processor 106. In another embodiment, the 2:1 switch may route USB mouse signals via the USB D+ signal line 422 and the USB D− signal line 426, and PS/2 keyboard signals may be transmitted via the PS/2 Data signal line 450 and the PS/2 CLK signal line 452 between the computer connector 102 and the processor 106.

Please refer to FIG. 4B. FIG. 4B shows another detailed diagram of the computer connector 102, the processor 106, the detecting link 108, and another type of the selector 112, based on the interface adapter 280 in FIG. 3A. The USB D+ signal line 422 and the PS/2 Data signal line 424 are connected together, i.e. in a tap form, and the USB D− signal line 426 and the PS/2 CLK signal line 428 are connected together. The processor 106 controls to output PS/2 signals or USB signals to the computer connector 102 according to the interface of the computer 140 but without the selector 112. Resistors 400, 402, 404, and 406 are used for limiting inrush current to protect the processor 106 from damage. The processor 106 outputs USB mouse and keyboard signals to the computer connector 102 via the USB D+ signal line 422 and the USB D− signal line 426. The processor 106 outputs PS/2 mouse signals to the computer connector 102 via the PS/2 CLK signal line 428 and the PS/2 Data signal line 424 when the processor outputs PS/2 keyboard signals to the computer connector 102 via the PS/2 CLK signal line 452 and the PS/2 Data signal line 450. The processor 106 outputs PS/2 keyboard signals to the computer connector 102 via the PS/2 CLK signal line 428 and the PS/2 Data signal line 424 when the processor outputs PS/2 mouse signals to the computer connector 102 via the PS/2 CLK signal line 452 and the PS/2 Data signal line 450.

In one embodiment, the processor 106 outputs USB keyboard signals to the computer connector 102 via the USB D+ signal line 422 and the USB D− signal line 426, and the PS/2 mouse signal may be transmitted from the processor 106 via the PS/2 Data signal line 450 and the PS/2 CLK signal line 452 between the computer connector 102 and the processor 106. In another embodiment, the processor 106 outputs USB mouse signals to the computer connector 102 via the USB D+ signal line 422 and the USB D− signal line 426, and the PS/2 keyboard signal may be transmitted from the processor 106 via the PS/2 Data signal line 450 and the PS/2 CLK signal line 452 between the computer connector 102 and the processor 106.

Please refer to FIG. 4C. FIG. 4C shows a detailed diagram of the computer connector 102, the processor 106, the detecting link 108, and the selector 112, based on the interface adapter 280 in FIG. 3B. The reserved Pin 2 or reserved Pin 6 of the PS/2 interface is connected to the V_{bus} pin of the USB interface. The detecting link 108 comprises a resistor 444, a first end of the resistor 444 is connected to a ground terminal, and a second end of the resistor 444 is connected to the detecting pin 118. In one embodiment, the selector 112 is a 2:1 switch. The processor 206 controls the 2:1 switch to route PS/2 signals when the processor detects that the detecting link 108 provides a first level. The processor 106 controls the 2:1 switch to route USB signals when the processor 106 detects that the detecting link 108 and the computer 140 provide a second level. In another embodiment, the 2:1 switch may be connected to the detecting link 108 and is not controlled by the processor 106. The 2:1 switch is switched to route PS/2 signals when the detecting link 108 provides a first level. The 2:1 switch is switched to route USB signals when the detecting link 108 and the computer 140 provide a second level. The processor 106 outputs one of the PS/2 signals and the USB signals and enables the selector 112 to output the PS/2 signals or the USB signals to the computer connector 102 depending on the voltage level of the detecting pin 118, i.e. according to the interface of the computer 140.

In one embodiment, the processor 106 outputs PS/2 mouse signals to the selector 112 via a PS/2 CLK signal line 436 and a PS/2 Data signal line 432 when the processor outputs PS/2 keyboard signals to the computer connector 102 via a PS/2 CLK signal line 456 and a PS/2 Data signal line 454. In another embodiment, the processor 106 outputs PS/2 keyboard signals to the selector 112 via the PS/2 CLK signal line 436 and the PS/2 Data signal line 432 when the processor outputs PS/2 mouse signals to the computer connector 102 via the PS/2 CLK signal line 456 and the PS/2 Data signal line 454.

When the 2:1 switch routes the USB signals between the computer connector 102 and the processor 106, the 2:1 switch may route USB keyboard and mouse signals via a USB D+ signal line 430 and a USB D− signal line 434. In one embodiment, the 2:1 switch may route USB keyboard signals via the USB D+ signal line 430 and the USB D− signal line 434, and PS/2 mouse signal may be transmitted via the PS/2 Data signal line 454 and the PS/2 CLK signal line 456 between the computer connector 102 and the processor 106. In another embodiment, the 2:1 switch may route USB mouse signals via the USB D+ signal line 430 and the USB D− signal line 434, and PS/2 keyboard signal may be transmitted via the PS/2 Data signal line 454 and the PS/2 CLK signal line 456 between the computer connector 102 and the processor 106.

A resistor 408 is used for limiting inrush current to protect the processor 106 from damage. In one embodiment, a value of the resistor 408 is lower than that of the resistor 444. The value of the resistor 408 is 1K ohm. The value of the resistor 444 is 10K ohm.

Please refer to FIG. 4D. FIG. 4D shows another detailed diagram of the computer connector 102, the processor 106, the detecting link 108, and another type of the selector 112, based on the interface adapter 280 in FIG. 3B. The USB D+ signal line 430 and the PS/2 Data signal line 432 are connected together, i.e. in a tap form, and the USB D− signal line 434 and the PS/2 CLK signal line 436 are connected together. The processor 106 controls to output PS/2 signals or USB signals to the computer connector 102 according to the interface of the computer 140 but without the selector 112. Resistors 408, 412, 414, 416, 418 are used for limiting inrush current to protect the processor 106 from damage.

The processor 106 outputs USB mouse and keyboard signals to the computer connector 102 via the USB D+ signal line 430 and the USB D− signal line 434. The processor 106 outputs PS/2 mouse signals to the computer connector 102 via the PS/2 CLK signal line 436 and the PS/2 Data signal line 432 when the processor outputs PS/2 keyboard signals to the computer connector 102 via the PS/2 CLK signal line 456 and the PS/2 Data signal line 454. The processor 106 outputs PS/2 keyboard signals to the computer connector 102 via the PS/2 CLK signal line 436 and the PS/2 Data signal line 432 when the processor outputs PS/2 mouse signals to the computer connector 102 via the PS/2 CLK signal line 456 and the PS/2 Data signal line 454.

In one embodiment, the processor 106 outputs USB keyboard signals to the computer connector 102 via the USB D+ signal line 430 and the USB D− signal line 434, and PS/2 mouse signals may be transmitted from the processor 106 via the PS/2 Data signal line 454 and the PS/2 CLK signal line 456 between the computer connector 102 and the processor 106. In another embodiment, the processor 106 outputs USB mouse signals to the computer connector 102 via the USB D+ signal line 430 and the USB D− signal line 434, and PS/2 keyboard signals may be transmitted from the processor 106 via the PS/2 Data signal line 454 and the PS/2 CLK signal line 456 between the computer connector 102 and the processor 106.

Please refer to FIG. 1, FIG. 3A and FIG. 4A. FIG. 4A shows a detailed diagram of the computer connector 102, the processor 106, the detecting link 108, and the selector 112, based on the interface adapter 280 in FIG. 3A. In FIG. 3A, the reserved Pin 2 or reserved Pin 6 of the PS/2 interface is connected to the GND pin of the USB interface. The detecting link 108 comprises a resistor 440, a first end of the resistor 440 is connected to a power supply terminal VCC, and a second end of the resistor 440 is connected to the detecting pin 118. In one embodiment, the selector 112 is a 2:1 switch. The processor 106 controls the 2:1 switch to route PS/2 signals when the processor 106 detects that the detecting link 108 provides a first level. In another embodiment, the 2:1 switch may be connected to the detecting link 108 and is not controlled by the processor 106. The 2:1 switch is switched to route PS/2 signals when the detecting link 108 provides a first level. The processor 106 outputs the PS/2 signals and enables the selector 112 to output the PS/2 signals to the computer connector 102 depending on the voltage level of the detecting pin 118, i.e. according to the interface of the computer 140.

In one embodiment, the processor 106 outputs PS/2 mouse signals to the selector 112 via the PS/2 CLK signal line 428 and the PS/2 Data signal line 424 when the processor outputs PS/2 keyboard signals to the computer connector 102 via the PS/2 CLK signal line 452 and the PS/2 Data signal line 450.

In another embodiment, the processor 106 outputs PS/2 keyboard signals to the selector 112 via the PS/2 CLK signal line 428 and the PS/2 Data signal line 424 when the processor outputs PS/2 mouse signals to the computer connector 102 via the PS/2 CLK signal line 452 and the PS/2 Data signal line 450.

The selector 112 could be in another pins-connection to achieve the same function. Please refer to FIG. 1, FIG. 3A and FIG. 4B. FIG. 4B shows another detailed diagram of the computer connector 102, the processor 106, the detecting link 108, and another type of the selector 112, based on the interface adapter 280 in FIG. 3A. The USB D+ signal line 422 and the PS/2 Data signal line 424 are connected together, i.e. in a tap form, and the USB D− signal line 426 and the PS/2 CLK signal line 428 are connected together. The processor 106 controls to output PS/2 signals to the computer connector 102 according to the interface of the computer 140 but without the selector 112.

In one embodiment, the processor 106 outputs PS/2 mouse signals to the computer connector 102 via the PS/2 CLK signal line 428 and the PS/2 Data signal line 424 when the processor outputs PS/2 keyboard signals to the computer connector 102 via the PS/2 CLK signal line 452 and the PS/2 Data signal line 450. In another embodiment, the processor 106 outputs PS/2 keyboard signals to the computer connector 102 via the PS/2 CLK signal line 428 and the PS/2 Data signal line 424 when the processor outputs PS/2 mouse signals to the computer connector 102 via the PS/2 CLK signal line 452 and the PS/2 Data signal line 450.

Please refer to FIG. 1, FIG. 3B, and FIG. 4C. FIG. 4C shows a detailed diagram of the computer connector 102, the processor 106, the detecting link 108, and the selector 112, based on the interface adapter 280 in FIG. 3B. The reserved Pin 2 or reserved Pin 6 of the PS/2 interface is connected to the V_{bus} pin of the USB interface. The detecting link 108 comprises a resistor 444, a first end of the resistor. 444 is connected to a ground terminal, and a second end of the resistor 444 is connected to the detecting pin 118. In one embodiment, the selector 112 is a 2:1 switch. The processor 206 controls the 2:1 switch to route PS/2 signals when the processor detects that the detecting link 108 provides a first level. In another embodiment, the 2:1 switch may be connected to the detecting link 108 and is not controlled by the processor 106. The 2:1 switch is switched to route PS/2 signals when the detecting link 108 provides a first level. The processor 106 outputs the PS/2 signals and enables the selector 112 to output the PS/2 signals to the computer connector 102 depending on the voltage level of the detecting pin 118, i.e. according to the interface of the computer 140.

In one embodiment, the processor 106 outputs PS/2 mouse signals to the selector 112 via the PS/2 CLK signal line 436 and the PS/2 Data signal line 432 when the processor outputs PS/2 keyboard signals to the computer connector 102 via the PS/2 CLK signal line 456 and the PS/2 Data signal line 454. In another embodiment, the processor 106 outputs PS/2 keyboard signals to the selector 112 via the PS/2 CLK signal line 436 and the PS/2 Data signal line 432 when the processor outputs PS/2 mouse signals to the computer connector 102 via the PS/2 CLK signal line 456 and the PS/2 Data signal line 454.

The selector 112 could be in another pins-connection to achieve the same function. Please refer to FIG. 1, FIG. 3B, and FIG. 4D. FIG. 4D shows another detailed diagram of the computer connector 102, the processor 106, the detecting link 108, and another type of the selector 112, based on the interface adapter 280 in FIG. 3B. The USB D+ signal line 430 and the PS/2 Data signal line 432 are connected together, i.e. in a tap form, and the USB D− signal line 434 and the PS/2 CLK signal line 436 are connected together. The processor 106 controls to output PS/2 signals to the computer connector 102 according to the interface of the computer 140 but without the selector 112

In one embodiment, the processor 106 outputs PS/2 mouse signals to the computer connector 102 via the PS/2 CLK signal line 436 and the PS/2 Data signal line 432 when the processor outputs PS/2 keyboard signals to the computer connector 102 via the PS/2 CLK signal line 456 and the PS/2 Data signal line 454. In another embodiment, the processor 106 outputs PS/2 keyboard signals to the computer connector 102 via the PS/2 CLK signal line 436 and the PS/2 Data signal line 432 when the processor outputs PS/2 mouse signals to the computer connector 102 via the PS/2 CLK signal line 456 and the PS/2 Data signal line 454.

Please refer to FIG. 2, FIG. 3A and FIG. 4A. The processor 106 controls the 2:1 switch to route PS/2 signals when the processor 106 detects that the detecting link 108 provides a first level. The processor 106 controls the 2:1 switch to route USB signals when the processor 106 detects that the detecting link 108 and the computer 140 provide a second level. In one embodiment, the 2:1 switch may be connected to the detecting link 108 and is not controlled by the processor 106. The 2:1 switch is switched to route USB signals when the detecting link 108 and the computer 140 provide a second level. The processor 106 outputs the USB signals and enables the selector 112 to output the USB signals to the computer connector 102 depending on the voltage level of the detecting pin 118, i.e. according to the interface of the computer 140.

When the 2:1 switch routes the USB signals between the computer 140 and the processor 106, the 2:1 switch may route USB keyboard and mouse signals via the USB D+ signal line 422 and the USB D− signal line 426. In one embodiment, the 2:1 switch may route USB keyboard signals via the USB D+ signal line 422 and the USB D− signal line 426, and PS/2 mouse signals may be transmitted via the PS/2 Data signal line 450 and the PS/2 CLK signal line 452 between the computer connector 102 and the processor 106. In another embodiment, the 2:1 switch may route USB mouse signals via the USB D+ signal line 422 and the USB D− signal line 426, and PS/2 keyboard signals may be transmitted via the PS/2 Data signal line 450 and the PS/2 CLK signal line 452 between the computer connector 102 and the processor 106.

Please refer to FIG. 2, FIG. 3A and FIG. 4B. The processor 106 controls to output USB signals to the computer connector 102 according to the interface of the computer 140 but without the selector 112. In one embodiment, the processor 106 outputs USB keyboard signals to the computer connector 102 via the USB D+ signal line 422 and the USB D− signal line 426, and PS/2 mouse signals may be transmitted from the processor 106 via the PS/2 Data signal line 450 and the PS/2 CLK signal line 452 between the computer connector 102 and the processor 106. In another embodiment, the processor 106 outputs USB mouse signals to the computer connector 102 via the USB D+ signal line 422 and the USB D− signal line 426, and PS/2 keyboard signals may be transmitted from the processor 106 via the PS/2 Data signal line 450 and the PS/2 CLK signal line 452 between the computer connector 102 and the processor 106. In other embodiment, the processor 106 outputs USB mouse and keyboard signals to the computer connector 102 via the USB D+ signal line 422 and the USB D− signal line 426.

Please refer to FIG. 2, FIG. 3B, and FIG. 4C. The processor 206 controls the 2:1 switch to route PS/2 signals when the processor detects that the detecting link 108 provides a first level. The processor 106 controls the 2:1 switch to route USB signals when the processor 106 detects that the detecting link 108 and the computer 140 provide a second level. In one embodiment, the 2:1 switch may be connected to the detecting link 108 and is not controlled by the processor 106. The 2:1 switch is switched to route USB signals when the detecting link 108 and the computer 140 provide a second level. The processor 106 outputs the USB signals and enables the selector 112 to output the USB signals to the computer connector 102 depending on the voltage level of the detecting pin 118, i.e. according to the interface of the computer 140.

When the 2:1 switch routes the USB signals between the computer connector 102 and the processor 106, the 2:1 switch may route USB keyboard and mouse signals via the USB D+ signal line 430 and the USB D− signal line 434. In one embodiment, the 2:1 switch may route USB keyboard signals via the USB D+ signal line 430 and the USB D− signal line 434, and PS/2 mouse signals may be transmitted via the PS/2 Data signal line 454 and the PS/2 CLK signal line 456 between the computer connector 102 and the processor 106. In another embodiment, the 2:1 switch may route USB mouse signals via the USB D+ signal line 430 and the USB D− signal line 434, and PS/2 keyboard signals may be transmitted via the PS/2 Data signal line 454 and the PS/2 CLK signal line 456 between the computer connector 102 and the processor 106.

A resistor 408 is used for limiting inrush current to protect the processor 206 from damage. In one embodiment, a value of the resistor 408 is lower than that of the resistor 444. The value of the resistor 408 is 1K ohm. The value of the resistor 444 is 10K ohm.

Please refer to FIG. 2, FIG. 3B, and FIG. 4D. The USB D+ signal line 430 and the PS/2 Data signal line 432 are connected together, i.e. in a tap form, and the USB D− signal line 434 and the PS/2 CLK signal line 436 are connected together. As aforementioned, the processor 106 controls to output USB signals to the computer connector 102 according to the interface of the computer 140 but without the selector 112. In one embodiment, the processor 106 outputs USB keyboard signals to the computer connector 102 via the USB D+ signal line 430 and the USB D− signal line 434, and PS/2 mouse signals may be transmitted from the processor 106 via the PS/2 Data signal line 454 and the PS/2 CLK signal line 456 between the computer connector 102 and the processor 106. In another embodiment, the processor 106 outputs USB mouse signals to the computer connector 102 via the USB D+ signal line 430 and the USB D− signal line 434, and PS/2 keyboard signals may be transmitted from the processor 106 via the PS/2 Data signal line 454 and the PS/2 CLK signal line 456 between the computer connector 102 and the processor 106. In other embodiment, the processor 106 outputs USB mouse and keyboard signals to the computer connector 102 via the USB D+ signal line 430 and the USB D− signal line 434.

It is noted that the interface adapter 280 in FIG. 3A is used to match with the detecting link 108 in FIG. 4A or in FIG. 4B, and the interface adapter 280 in FIG. 3B is used to match with the detecting link 108 in FIG. 4C or in FIG. 4D.

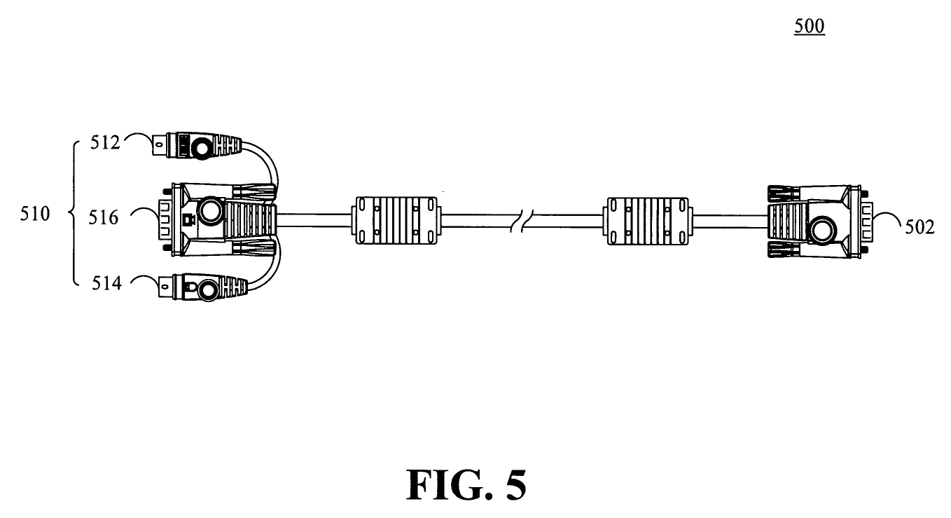

Please refer to FIG. 5, which shows a diagram of a cable 500. The cable 500 comprises a KVM connector 502 and a set of computer signal connectors 510. The KVM connector 502 is coupled to the computer connectors 102, 104 in FIG. 1 or in FIG. 2. The set of computer signal connectors 510 has a PS/2 keyboard connector 512, a PS/2 mouse connector 514, and a video signal connector 516. The set of computer signal connectors 510 is coupled to the computers 140, 142 in FIG. 1. At least one of the PS/2 keyboard connector 512 and the PS/2 mouse connector 514 is connected to the interface adapters 280, 282 in FIG. 2.

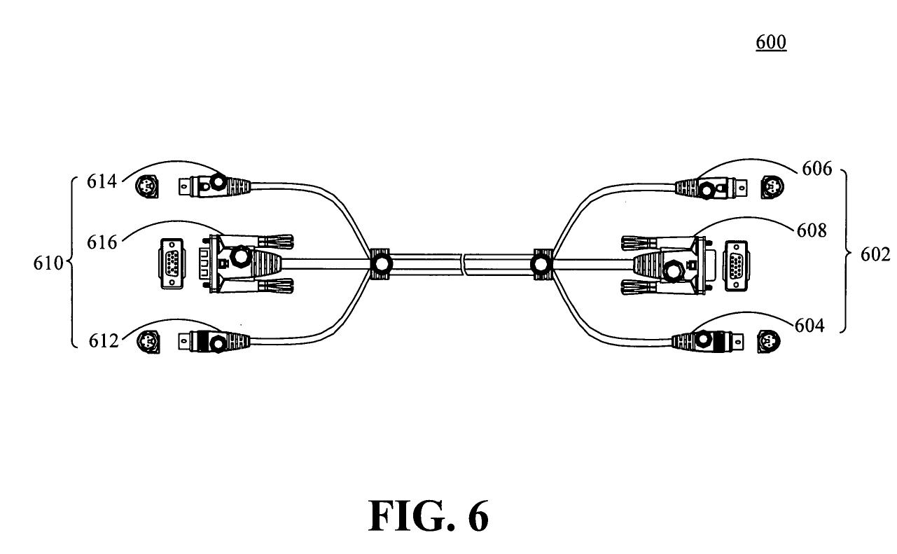

Please refer to FIG. 6, which shows a diagram of another type of cable 600. The cable 600 comprises a set of KVM connectors 602 and a set of computer signal connectors 610. The set of KVM connectors 602 is coupled to the computer connectors 102, 104 in FIG. 1 or in FIG. 2, and has a PS/2 keyboard connector 604, a PS/2 mouse connector 606, and a video signal connector 608. The set of computer signal connectors 610 has a PS/2 keyboard connector 612, a PS/2 mouse connector 614, and a video signal connector 616. The set of computer signal connectors 610 is coupled to the computers 140, 142 in FIG. 1. At least one of the PS/2 keyboard connector 612 and the PS/2 mouse connector 614 is connected to the interface adapters 280, 282 in FIG. 2. The PS/2 keyboard connector 604, the PS/2 mouse connector 606, and the video signal connector 608 are connected to the PS/2 keyboard connector 612, the PS/2 mouse connector 614, and the video signal connector 616, respectively.

According to the present invention, the KVM switch system is capable of detecting the interface of the computer coupled thereto. And the user can use the interface adapter of the present invention connected to a PS/2 interface cable to control computers equipped with USB interface instead of the USB interface cable. That is, the user may use a PS/2 interface cable and an interface adapter to control computers equipped with PS/2 interface or USB interface according to demands, and thus reducing cost of providing two cables especially when controlling a large number of computers.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A keyboard-video-mouse (KVM) switch system, comprising:
a computer connector, coupled to a computer, having at least one detecting pin;
a processor, coupled to the computer connector; and
a detecting link connecting between the detecting pin and the processor, wherein the processor outputs a first signal to the computer via the computer connector when the processor detects that the detecting link provides a first level.

2. The KVM switch system according to claim 1, wherein the processor outputs a second signal to the computer via the computer connector when the processor detects that the detecting link and the computer provide a second level.

3. The KVM switch system according to claim 2, wherein the processor detects that the detecting link is at the second level when an interface adapter is coupled between the computer connector and the computer.

4. The KVM switch system according to claim 2, wherein the detecting link is at the first level or at the second level depending on a voltage level of the detecting pin.

5. The KVM switch system according to claim 2, further comprising a selector coupling the computer connector and the detecting link to the processor, wherein the processor enables the selector to output the first signal or the second signal to the computer.

6. The KVM switch system according to claim 2, wherein signal lines of the first signal and signal lines of the second signal are connected in a tap form and the processor determines to output the first signal or the second signal to the computer.

7. The KVM switch system according to claim 3, wherein the interface adapter comprises:
a PS/2 interface, having a reserved pin;
a USB interface, having a power pin connected to the reserved pin.

8. The KVM switch system according to claim 7, wherein the power pin of the USB interface is a V_{bus 0}pin.

9. The KVM switch system according to claim 7, wherein the power pin of the USB interface is a ground pin.

10. The KVM switch system according to claim 3, further comprising a cable coupled between the computer connector and the interface adapter.

11. The KVM switch system according to claim 10, wherein the cable comprises:
a KVM connector, coupled to the computer connector; and
a set of computer signal connectors, having a video signal connector and at least one peripheral signal connector, coupled to the computer and the interface adapter.

12. The KVM switch system according to claim 10, wherein the cable comprises:
a set of KVM connectors, having a video signal connector and at least one peripheral signal connectors, coupled to the computer connector; and
a set of computer signal connectors, having another video signal connector and at least another peripheral signal connector, coupled to the computer and the interface adapter.

13. The KVM switch system according to claim 1, further comprising a cable coupled between the KVM switch system and the computer.

14. The KVM switch system according to claim 13, wherein the cable comprises:
a KVM connector, coupled to the computer connector; and
a set of computer signal connectors, having a video signal connector and at least one peripheral signal connector, coupled to the computer.

15. The KVM switch system according to claim 13, wherein the cable comprises:
a set of KVM connectors, having a video signal connector and at least one peripheral signal connectors, coupled to the computer connector; and
a set of computer signal connectors, having another video signal connector and at least another peripheral signal, coupled to the computer.

16. An interface adapter for coupling a computer connector of a keyboard-video-mouse (KVM) switch system to a computer, wherein a processor of the KVM switch system outputs a first signal to the computer via the computer connector when the processor detects that a detecting link of the KVM switch system is at a first level, the interface adapter comprising:
a PS/2 interface, having a reserved pin; and
a USB interface, having a power pin connected to the reserved pin for providing a voltage level to the detecting link of the KVM switch system through a detecting pin of the computer connector,
wherein the processor outputs a second signal to the computer when the interface adapter is coupled between the computer connector and the computer, and the processor detects that the detecting link is at a second level

17. The interface adapter according to claim 16, wherein the detecting link is at the first level or at the second level depending on the voltage level provided by the USB interface.

18. The interface adapter according to claim 16, wherein the voltage level is generated by the computer.

19. The interface adapter according to claim 16, wherein the power pin of the USB interface is a V_{bus} pin.

20. The interface adapter according to claim 16, wherein the power pin of the USB interface is a ground pin.
